(19) United States
(12) Patent Application Publication
(10) Pub. No.: US 2024/0386338 A1
(43) Pub. Date: Nov. 21, 2024

(54) END-TO-END ENTERPRISE SAAS LICENSE LIFECYCLE OPTIMIZATION

(71) Applicant: Snowflake Inc., Bozeman, MT (US)

(72) Inventors: Patrick Sean Bacon, Fremont, CA (US); Sandeep Chandana, Fremont, CA (US); Arpit Parihar, San Mateo, CA (US); Ameya Mahesh Sanzgiri, Fremont, CA (US)

(21) Appl. No.: 18/524,920

(22) Filed: Nov. 30, 2023

Related U.S. Application Data
(60) Provisional application No. 63/503,404, filed on May 19, 2023.

(51) Int. Cl. G06F 21/10; G06F 21/31

(52) U.S. Cl. CPC G06Q 10/04; G06Q 2220/18

(57) ABSTRACT

The subject technology analyzes a set of authentication logs of users of an application. The subject technology generates a baseline of activity for the application based at least in part on the analyzing. The subject technology trains, using the baseline of activity, a machine learning model for each user of the application. The subject technology generates, using the trained machine learning model, a probability of usage for the application over a particular period of time. The subject technology triggers a license revocation process based at least in part on the probability of usage, the license revocation process revoking a set of licenses for the application. The subject technology allocates the set of licenses to a new set of users for using the application.

### CROSS-REFERENCE TO RELATED APPLICATIONS

This application claims priority to U.S. Provisional Patent Application Ser. No. 63/503,404, filed May 19, 2023, entitled “END-TO-END ENTERPRISE SAAS LICENSE LIFECYCLE OPTIMIZATION,” and the contents of which is incorporated herein by reference in their entirety for all purposes.

### TECHNICAL FIELD

Embodiments of the disclosure relate generally to management of SaaS (Software as a Service) applications.

### BACKGROUND

SaaS is a software delivery model in which a cloud-based provider hosts applications and makes them available to end users over the internet (or other network). Instead of installing and maintaining software, users simply access it via the internet, freeing themselves from complex software and hardware management.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a network-based database system in communication with a cloud storage platform, in accordance with some embodiments of the present disclosure.

FIG. 2 is a block diagram illustrating components of a compute service manager, in accordance with some embodiments of the present disclosure.

FIG. 3 is a block diagram illustrating components of an execution platform, in accordance with some embodiments of the present disclosure.

FIG. 4 shows an example process flow of an access management framework in accordance with an embodiment of the subject technology.

FIG. 5 shows a process flow for various stages of access management in accordance with an embodiment of the subject technology.

FIG. 6 illustrates an example data process flow in accordance with an embodiment of the subject technology.

FIG. 7 illustrates an example interface in accordance with an embodiment of the subject technology.

FIG. 8 illustrates an example interface in accordance with an embodiment of the subject technology.

FIG. 9 is a flow diagram illustrating operations of a database system in performing a method, in accordance with some embodiments of the present disclosure.

FIG. 10 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

SaaS application rationalization is a strategic process that involves analyzing an organization's existing SaaS applications portfolio to identify and address inefficiencies, redundancies, and potential cost savings. The goal of this process is to optimize the use of SaaS applications within the organization, ensuring they align with business goals and requirements while minimizing costs and risks.

SaaS application rationalization affects many organizations and causes unnecessary economic burdens as well as compliance issues. Enterprises also have to balance their approach to SaaS Applications' revocations with employee experience.

Embodiments of the subject technology provide techniques, using at least machine learning models, that effectively convert a set of software licenses based on capacity to software licenses that behave similar to a consumption model.

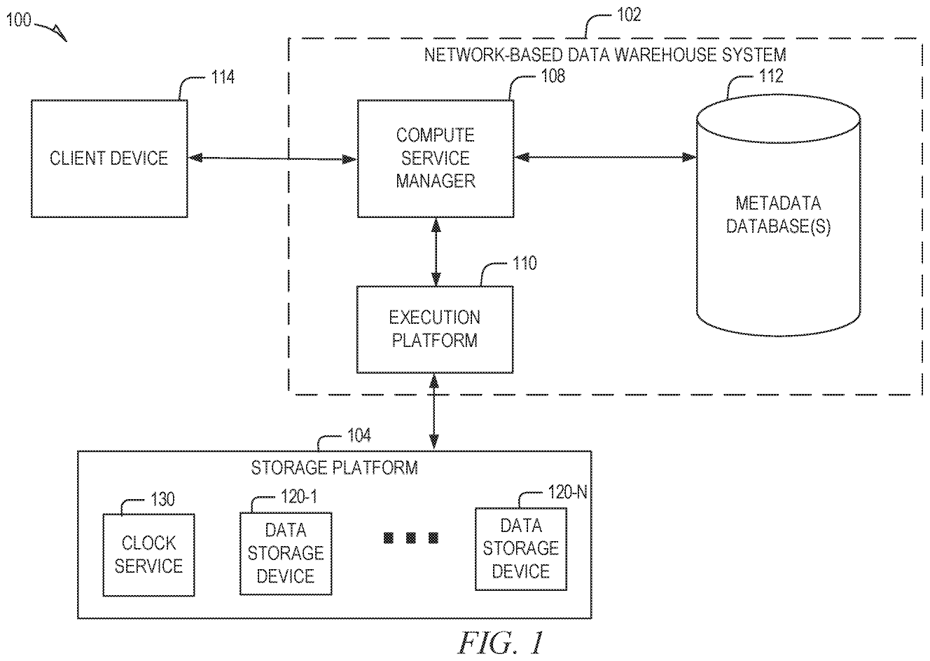

FIG. 1 illustrates an example computing environment 100 that includes a database system in the example form of a network-based database system 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other embodiments, the computing environment may comprise another type of network-based database system or a cloud data platform.

As shown, the computing environment 100 comprises the network-based database system 102 in communication with a cloud storage platform 104 (e.g., AWS®, Microsoft Azure Blob Storage®, or Google Cloud Storage). The network-based database system 102 is a network-based system used for reporting and analysis of integrated data from one or more disparate sources including one or more storage locations within the cloud storage platform 104. The cloud storage platform 104 comprises a plurality of computing machines and provides on-demand computer system resources such as data storage and computing power to the network-based database system 102.

The network-based database system 102 comprises a compute service manager 108, an execution platform 110, and one or more metadata databases 112. The network-based database system 102 hosts and provides data reporting and analysis services to multiple client accounts.

The compute service manager 108 coordinates and manages operations of the network-based database system 102. The compute service manager 108 also performs query optimization and compilation as well as managing clusters of computing services that provide compute resources (also referred to as “virtual warehouses”). The compute service manager 108 can support any number of client accounts such as end users providing data storage and retrieval requests, system administrators managing the systems and methods described herein, and other components/devices that interact with compute service manager 108.

The compute service manager 108 is also in communication with a client device 114. The client device 114 corresponds to a user of one of the multiple client accounts supported by the network-based database system 102. A user may utilize the client device 114 to submit data storage, retrieval, and analysis requests to the compute service manager 108.

The compute service manager 108 is also coupled to one or more metadata databases 112 that store metadata pertaining to various functions and aspects associated with the network-based database system 102 and its users. For example, a metadata database 112 may include a summary of data stored in remote data storage systems as well as data available from a local cache. Additionally, a metadata database 112 may include information regarding how data is organized in remote data storage systems (e.g., the cloud storage platform 104) and the local caches. Information stored by a metadata database 112 allows systems and services to determine whether a piece of data needs to be accessed without loading or accessing the actual data from a storage device.

The compute service manager 108 is further coupled to the execution platform 110, which provides multiple computing resources that execute various data storage and data retrieval tasks. The execution platform 110 is coupled to storage platform 104 of the cloud storage platform 104. The storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid state drives (SSDs), storage clusters, Amazon S3™ storage systems, or any other data storage technology. Additionally, the cloud storage platform 104 may include distributed file systems (such as Hadoop Distributed File Systems (HDFS)), object storage systems, and the like.

As further shown, the storage platform 104 includes clock service 130 which can be contacted to fetch a number that will be greater than any number previously returned, such as one that correlates to the current time. Clock service 130 is discussed further herein below with respect to embodiments of the subject system.

The execution platform 110 comprises a plurality of compute nodes. A set of processes on a compute node executes a query plan compiled by the compute service manager 108. The set of processes can include: a first process to execute the query plan; a second process to monitor and delete cache files using a least recently used (LRU) policy and implement an out of memory (OOM) error mitigation process, a third process that extracts health information from process logs and status to send back to the compute service manager 108; a fourth process to establish communication with the compute service manager 108 after a system boot, and a fifth process to handle all communication with a compute cluster for a given job provided by the compute service manager 108 and to communicate information back to the compute service manager 108 and other compute nodes of the execution platform 110.

In some embodiments, communication links between elements of the computing environment 100 are implemented via one or more data communication networks. These data communication networks may utilize any communication protocol and any type of communication medium. In some embodiments, the data communication networks are a combination of two or more data communication networks (or sub-networks) coupled to one another. In alternative embodiments, these communication links are implemented using any type of communication medium and any communication protocol.

The compute service manager 108, metadata database(s) 112, execution platform 110, and storage platform 104, are shown in FIG. 1 as individual discrete components. However, each of the compute service manager 108, metadata database(s) 112, execution platform 110, and storage platform 104 may be implemented as a distributed system (e.g., distributed across multiple systems/platforms at multiple geographic locations). Additionally, each of the compute service manager 108, metadata database(s) 112, execution platform 110, and storage platform 104 can be scaled up or down (independently of one another) depending on changes to the requests received and the changing needs of the network-based database system 102. Thus, in the described embodiments, the network-based database system 102 is dynamic and supports regular changes to meet the current data processing needs.

During typical operation, the network-based database system 102 processes multiple jobs determined by the compute service manager 108. These jobs are scheduled and managed by the compute service manager 108 to determine when and how to execute the job. For example, the compute service manager 108 may divide the job into multiple discrete tasks (or transactions as discussed further herein) and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in a metadata database 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the cloud storage platform 104. It is desirable to retrieve as much data as possible from caches within the execution platform 110 because the retrieval speed is typically much faster than retrieving data from the cloud storage platform 104.

As shown in FIG. 1, the computing environment 100 separates the execution platform 110 from the storage platform 104. In this arrangement, the processing resources and cache resources in the execution platform 110 operate independently of the data storage devices 120-1 to 120-N in the cloud storage platform 104. Thus, the computing resources and cache resources are not restricted to specific data storage devices 120-1 to 120-N. Instead, all computing resources and all cache resources may retrieve data from, and store data to, any of the data storage resources in the cloud storage platform 104.

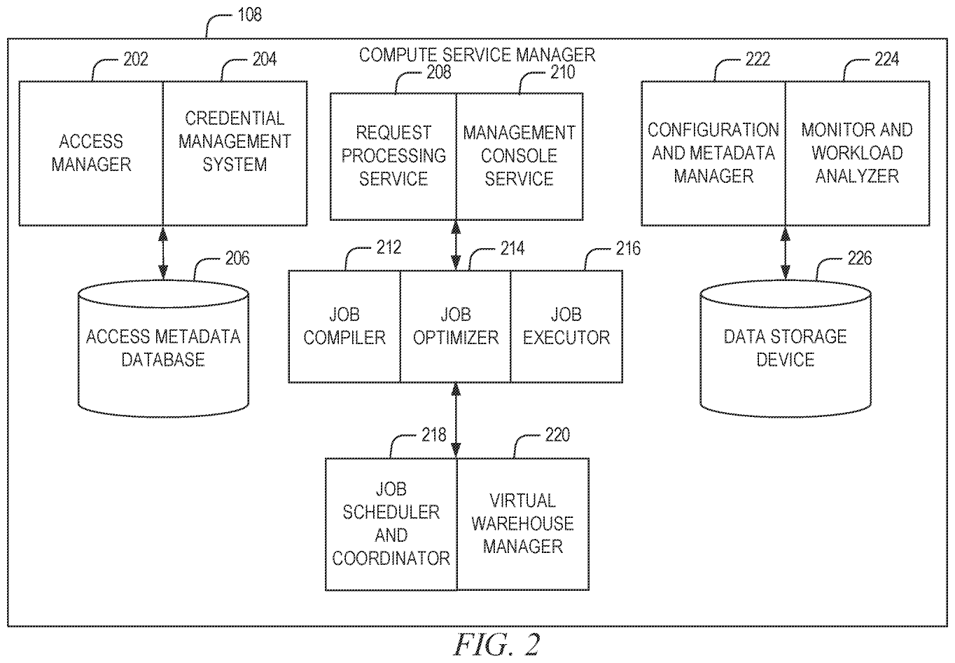

FIG. 2 is a block diagram illustrating components of the compute service manager 108, in accordance with some embodiments of the present disclosure. As shown in FIG. 2, the compute service manager 108 includes an access manager 202 and a credential management system 204 coupled to an access metadata database 206, which is an example of the metadata database(s) 112. Access manager 202 handles authentication and authorization tasks for the systems described herein. The credential management system 204 facilitates use of remote stored credentials to access external resources such as data resources in a remote storage device. As used herein, the remote storage devices may also be referred to as “persistent storage devices” or “shared storage devices.” For example, the credential management system 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214 and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and then processed in that prioritized order. In an embodiment, the job scheduler and coordinator 218 determines a priority for internal jobs that are scheduled by the compute service manager 108 with other “outside” jobs such as user queries that may be scheduled by other systems in the database (e.g., the storage platform 104) but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries.

Additionally, the compute service manager 108 includes a configuration and metadata manager 222, which manages the information related to the data stored in the remote data storage devices and in the local buffers (e.g., the buffers in execution platform 110). The configuration and metadata manager 222 uses metadata to determine which data files need to be accessed to retrieve data for processing a particular task or job. A monitor and workload analyzer 224 oversee processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the network-based database system 102 and may further redistribute tasks based on a user (e.g., “external”) query workload that may also be processed by the execution platform 110. The configuration and metadata manager 222 and the monitor and workload analyzer 224 are coupled to a data storage device 226. Data storage device 226 in FIG. 2 represents any data storage device within the network-based database system 102. For example, data storage device 226 may represent buffers in execution platform 110, storage devices in storage platform 104, or any other storage device.

In some embodiments, the compute service manager 108 validates all communication from an execution platform (e.g., the execution platform 110) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 302-1 may need to communicate with another execution node (e.g., execution node 302-2), and should be disallowed from communicating with a third execution node (e.g., execution node 312-1) and any such illicit communication can be recorded (e.g., in a log or other location). Also, the information stored on a given execution node is restricted to data relevant to the current query and any other data is unusable, rendered so by destruction or encryption where the key is unavailable.

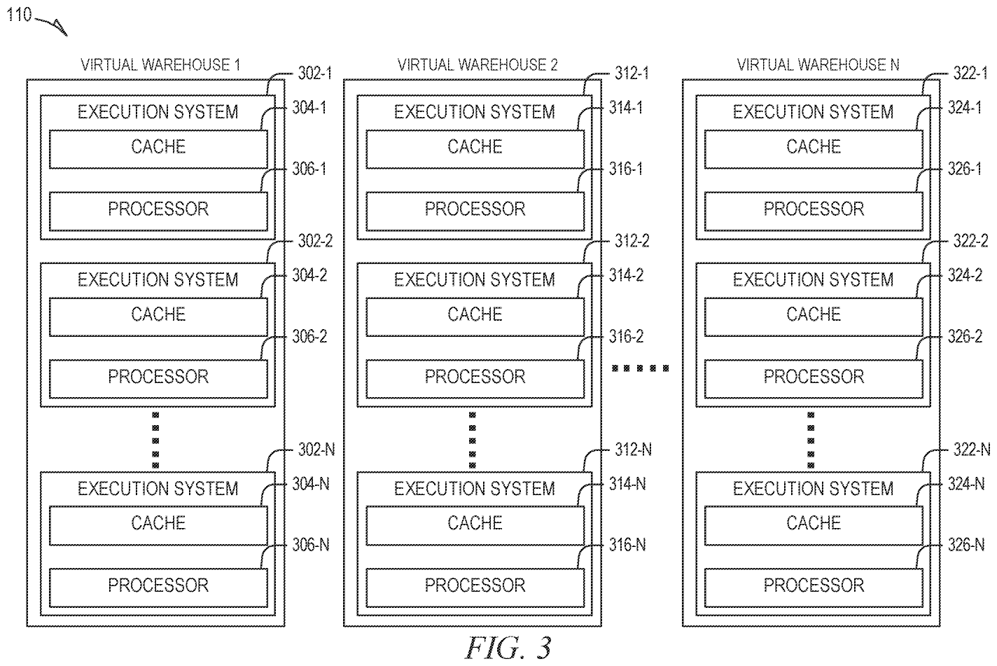

FIG. 3 is a block diagram illustrating components of the execution platform 110, in accordance with some embodiments of the present disclosure. As shown in FIG. 3, the execution platform 110 includes multiple virtual warehouses, including virtual warehouse 1, virtual warehouse 2, and virtual warehouse n. Each virtual warehouse includes multiple execution nodes that each include a data cache and a processor. The virtual warehouses can execute multiple tasks in parallel by using the multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in cloud storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 120-1 to 120-N shown in FIG. 1. Thus, the virtual warehouses are not necessarily assigned to a specific data storage device 120-1 to 120-N and, instead, can access data from any of the data storage devices 120-1 to 120-N within the cloud storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-n. Execution node 302-1 includes a cache 304-1 and a processor 306-1. Execution node 302-2 includes a cache 304-2 and a processor 306-2. Execution node 302-n includes a cache 304-n and a processor 306-n. Each execution node 302-1, 302-2, and 302-n is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-n. Execution node 312-1 includes a cache 314-1 and a processor 316-1. Execution node 312-2 includes a cache 314-2 and a processor 316-2. Execution node 312-n includes a cache 314-n and a processor 316-n. Additionally, virtual warehouse 3 includes three execution nodes 322-1, 322-2, and 322-n. Execution node 322-1 includes a cache 324-1 and a processor 326-1. Execution node 322-2 includes a cache 324-2 and a processor 326-2. Execution node 322-n includes a cache 324-n and a processor 326-n.

In some embodiments, the execution nodes shown in FIG. 3 are stateless with respect to the data being cached by the execution nodes. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternative embodiments may include execution nodes containing any number of processors and any number of caches. Additionally, the caches may vary in size among the different execution nodes. The caches shown in FIG. 3 store, in the local execution node, data that was retrieved from one or more data storage devices in cloud storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and n are associated with the same execution platform 110, the virtual warehouses may be implemented using multiple computing systems at multiple geographic locations. For example, virtual warehouse 1 can be implemented by a computing system at a first geographic location, while virtual warehouses 2 and n are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and implements execution node 302-n at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault tolerant. For example, if one virtual warehouse fails, that virtual warehouse is quickly replaced with a different virtual warehouse at a different geographic location.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in cloud storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

As mentioned before, SaaS application rationalization can be problematic for organizations and cause unnecessary economic burdens as well as compliance issues.

As mentioned herein a license refers to an enterprise SaaS software license that is an agreement that allows a business or organization (e.g., the enterprise) to use a software application that is hosted on the cloud. Such a license can be a multiple user license that allows for a particular number of users to use the software.

Some cost-conscious enterprises use arbitrary, subjective criteria to generate rules that determine which licenses are not being utilized and revoke those licenses; some even hire expensive consultants for essentially the same. However, these rules have to be generated on a per-app basis making them cost and time prohibitive.

The subject technology provides at least the following technical advantages.

The subject technology models how users interact with applications and considers aspects such as their recency, frequency along with their usage periodicity. This provides an accurate measure to rationalize applications and provides the ability to perform continuous license optimization.

License optimization enables revocations from users who are not using their licenses, and for those SaaS applications that are in demand-allows them to be recycled to other users. This provides a historical view of the capacity of the licenses which can then be leveraged for better forecasting as organizations grow.

Employee/User experience is a key facet for CIOs and IT departments. The subject technology provides a mechanism for automated access provisioning, user role/division cohorts, and measuring user experience. This is done via analyzing the user application behavior modeling to understand hotspots of an application usage and auto provisioning the applications access to new employees.

Reusing licenses that have been revoked provides the flexibility to repurpose them on almost an on-demand basis. This influences future purchase or renewal strategies with the ability to forecast the demand for any SaaS applications using the framework of continuous license optimizations to gain ground truth on usage patterns and capacities. The subject technology can also perform procurement scenario modeling by including various discount factors and providing procurement with the optimal license count which would provide the biggest win. Similarly, the system can also provide smart alerting when the entitlements vs allotments ratio falls below a certain threshold.

Using the constrained capacity modeling, licenses can be revoked from users who are inactive and reprovision it to users who have requested access to an application. This converts a licensed model to a consumption model.

The subject technology operates by analyzing the authentication/activity logs for an application across all users and generating a baseline of activity.

In an implementation, an ML model is trained on this baseline for each user. Such a model analyzes the recency and frequency of activity and/or authentication logs and converts them to activity patterns, then forecasts the probability of usage over a certain period.

Continuous (scheduled) or triggered license revocations can then be performed, based on the forecast of the aforementioned model.

The licenses revoked can then be allotted to new users, thus creating a rotational license pool where a certain number of licenses can be rotated between users.

Based on the revocation history as well as analysis of usage hotspots enable for automated access provisioning thus driving up employee experience.

The advantages of a data-driven system, such as the one described herein, are ensuring that compliance requirements are met, influencing future purchase strategies, and improving user experience, which are some of the important considerations for the IT (information technology) department of an organization (e.g., company, entity, and the like).

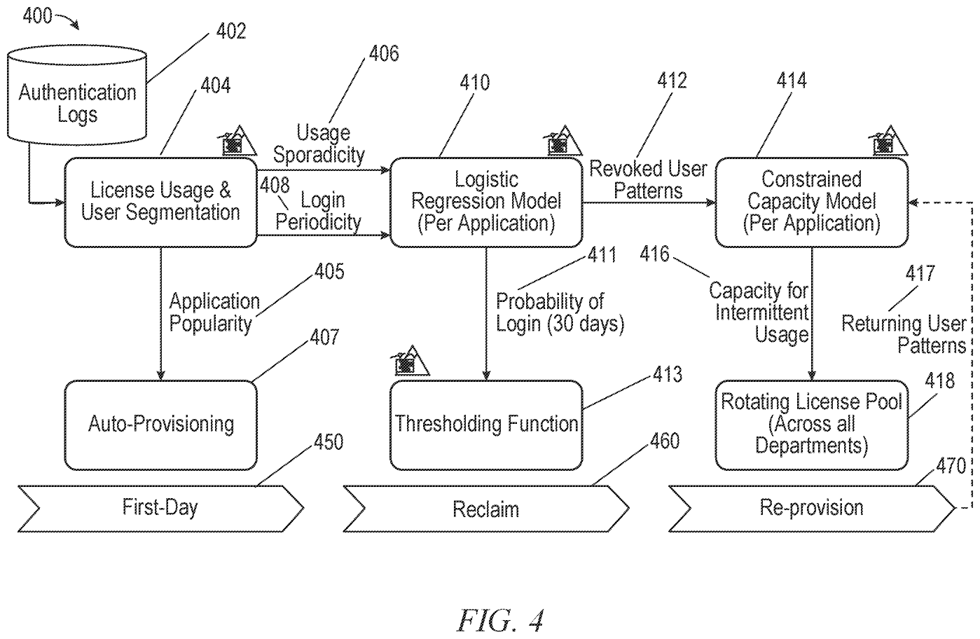

FIG. 4 shows an example process flow of an access management framework 400 in accordance with an embodiment of the subject technology. In an embodiment, such a process flow can be performed by components of the subject system, including for example a given execution node (e.g., execution node 302-1). In an embodiment, the process flow is performed by a compute service manager (e.g., compute service manager 108).

As illustrated, license usage and user segmentation 404 are extracted from authentication logs 402, and information related to usage sporadicity 406 (e.g., login frequency) and logging periodicity 408 (e.g., days since last login) are provided as input to a logistic regression model 410 (e.g., statistical model that models the probability of an event taking place by having the log-odds for the event be a linear combination of one or more independent variables). Each application is provided its own logistic regression model in this example, which utilizes the aforementioned information. The logistic regression (model) determines an output indicating a probability 411 that a user will login to a particular application. A thresholding function can be determined based at least in part on the probability. Such a thresholding function 413 is used to configure a degree (e.g., conversative, moderate, or aggressive, and the like) in which licenses are reclaimed (e.g., from other users during a reclaim stage 460). In an example, a set of users with a probability lower than a threshold are recommended for revocation. In an embodiment, the logistic regression model is a machine learning model (e.g., ensemble model or classifier model) that utilizes logistic regression techniques to predict such a probability.

To illustrate an example of setting a particular threshold, if a given organization (e.g., company or entity) has a first number of licenses (e.g., 400) for a particular application and there are a second number of users (e.g., 1000) that are joining the organization, the threshold can be set lower (e.g., being more aggressive) to revoke a number of licenses to meet the second number of users requiring such licenses.

Usage sporadicity and logging periodicity can be utilized for auto-provisioning. In an example, if there is a department within a company or entity that has 90 percent (or some other threshold percentage) of users that are using a particular application indicating a sufficient amount of application popularity 405, that application is auto-provisioned (e.g., undergoing an auto-provisioning process 407) on a first day (e.g. first day stage 450) of a new employee(s) starting work at the company or entity.

As further shown, the logistic regression model determines revoked user patterns 412 that are provided as input to a constrained capacity model 414. In an example, such a revoked user corresponds to a user in which a license was revoked. Further, returning user patterns 417 can be provided to the constrained capacity model 414 as input. In an example, the constrained capacity model is per application. The constrained capacity model provides an indication of a capacity for intermittent usage 416, which is used, at least in part, to determine a rotating licensing pool 418 (e.g., occurring during a re-provision stage 470 where one or more licenses are distributed to user(s)). As a result, a licensing scheme based on a number of seats can be treated (e.g., converted) to a consumption based model (e.g., using the rotating licensing pool). In an embodiment, the constrained capacity model 414 is a machine learning model.

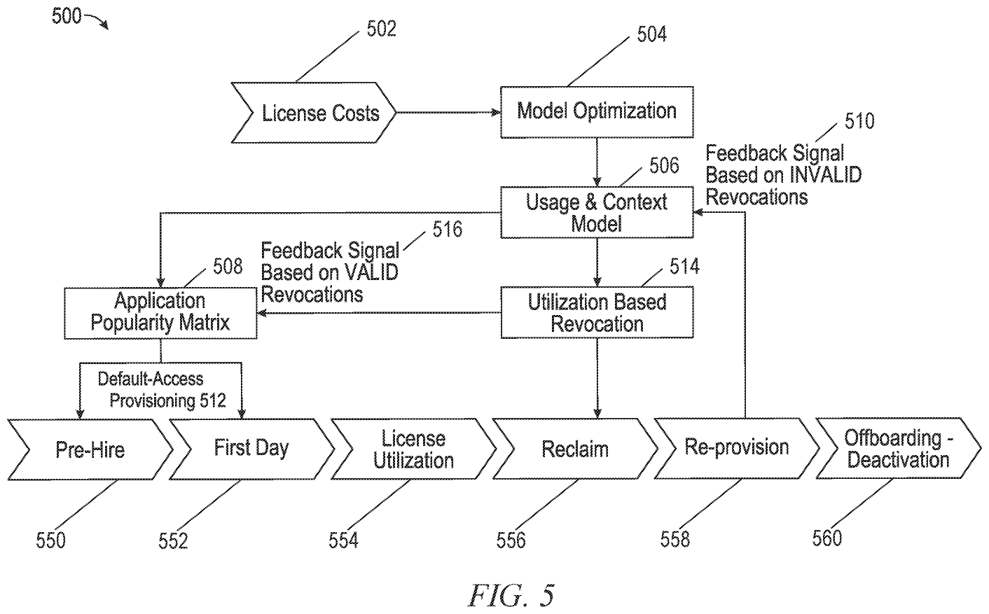

FIG. 5 shows a process flow 500 for various stages of access management in accordance with an embodiment of the subject technology. In an embodiment, such a process flow can be performed by components of the subject system, including for example a given execution node (e.g., execution node 302-1). In an embodiment, the process flow 500 is performed by a compute service manager (e.g., compute service manager 108).

In the example of FIG. 5, process flow 500 includes several stages including pre-hire stage 550, first day stage 552, license utilization stage 554, reclaim stage 556, re-provison stage 558, and offboarding-deactivation stage 560.

As shown, license costs 502 are received by a model optimization component 504. A usage and context model 506 can help generate an application popularity matrix 508 discussed further below. Further, the usage and context model 506 can receive a feedback signal 510 on invalid revocations from a re-provisioning stage, which can be used to modify the application popularity matrix. In an embodiment, the usage and context model is a machine learning model. In an embodiment, the application popularity matrix includes information related to a number of access requests (e.g., based on access tickets in a given IT system) for each application in which a license is (or can be) provided. As mentioned herein, the re-provisioning stage (e.g., re-provision stage 558) corresponds to an automatic provisioning of licenses to users who requested access after their licenses were revoked.

In an implementation, the application popularity matrix 508 is utilized for pre-hire and first day stages for a given employee or user. The application popularity matrix is utilized for default access provisioning 512 of a set of licenses in this example. Utilization based revocation component 514 provides a (first) feedback signal 516 based on valid revocations for updating the application popularity matrix 508. Further, the utilization based revocation component 514 is used for a reclaiming stage (e.g., reclaim stage 556).

As further shown, during a re-provisioning stage (e.g., re-provision stage 558), a (second) feedback signal 510, based on a set of invalid revocations, is sent to the usage and context model 506 for updating the model. In particular, the usage and context model 506 can be retrained based at least in part on this feedback signal. This updated (or retrained) model can then be utilized to update the application popularity matrix accordingly.

In view of the above, it should be understood that the subject system enables provisioning of licenses, not only for current users, but also for future users (yet to be hired or starting employees) of a set of applications.

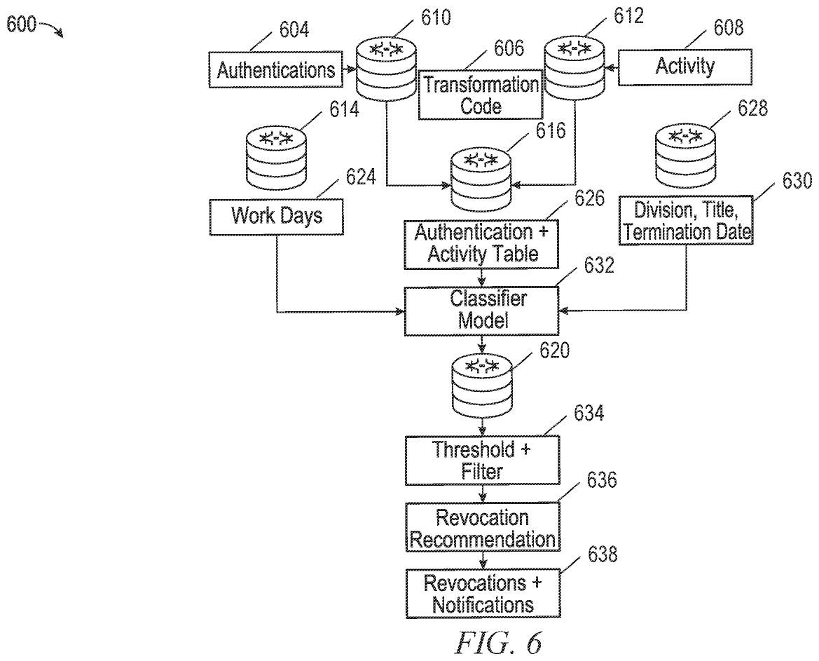

The following relates to a discussion of various terms or phrases discussed in at least FIG. 6 below.

As mentioned herein, authentication logs, e.g., Okta logs, are provided by an IdP (identity provider that creates, maintains, and manages identity information for principals (users) and also provides authentication services to relying applications within a federation or distributed network) or Okta (third party identity provider service/platform). In an example, such authentication logs act as a proxy for the activity of the user where an instance of authentication indicates that the user utilized a particular application or platform.

As mentioned herein, app or application logs are the authentication or activity logs provided directly by a vendor or SaaS application.

As mentioned herein, work days are the company's work schedule and holiday calendar. In an example, such work days are utilized to normalize the holidays based on geographical locations and not penalize employees based on holidays.

As mentioned herein, employee metadata includes metadata for all employees in a given company or entity. In an example, such employee metadata is utilized to create predictor variables based on employee department, division, and title and to exclude terminated users from model training.

FIG. 6 illustrates an example data process flow 600 in accordance with an embodiment of the subject technology. In an embodiment, such a process flow can be performed by components of the subject system, including for example a given execution node (e.g., execution node 302-1). In an embodiment, the process flow 600 is performed by a compute service manager (e.g., compute service manager 108).

As illustrated, Okta logs (or any other appropriate authentication log(s)) are received or provided in which authentications 604 (e.g., authentication data) are determined from the Okta logs and stored in a database 610. In an example, application logs are received or provided in which activity 608 (e.g., activity data) is derived from the application logs and stored in a database 612.

The following discussion relates to dataflow and transformations that are part of the subject system.

In an implementation, transformation code 606 (e.g., executed by execution node 302-1) is utilized to merge authentication logs and application logs, and then undergo binarization to have one row for each user and the date if the user authenticated that day. In an example, transformation code 606 performs a set of operations to transform authentication data and activity data into a format that is compatible for a classifier model discussed below. Such a format may be a database table (authentication and activity table 626) stored in database 616 that is able to be accessed by the classifier model (e.g., classifier model 632).

As further shown and mentioned above, classifier model 632 is provided. In an implementation, classifier model 632 utilizes at least logistic regression techniques discussed in at least FIG. 4 and FIG. 5 to provide a probability as an output of the model. Such a probability, in an example, indicates a likelihood of a user using a particular application (e.g., including logging into the application). Other techniques utilized by classifier model 632 include, but not limited to, naive Bayes, gradient descent, decision tree, nearest neighbors, support vector machines, random forest, and the like.

In an implementation, classifier model 632 receives data corresponding to work days 624 (stored in database 614) and data corresponding to division, title, termination date 630 (stored in database 628), and data from authentication and activity table 626 as inputs, and performs one or more techniques discussed herein to output the aforementioned probability.

A threshold and filter 634 is applied to the output (e.g., probability) that implements a thresholding function that determines a degree (e.g., conversative, moderate, or aggressive, and the like) in which licenses are reclaimed (e.g., from other users during a reclaim stage). After being processed by threshold and filter 634, a revocation recommendation 636 is generated to determine whether to revoke a number of licenses. Revocations and notifications 638 are then performed and provided to perform a license revocation process along with notifying user(s) of such license revocations.

The following discussion relates to various functions or operations that are provided by the subject system (e.g., executed by a given execution node such as execution model 302-1) which are connected or performed in conjunction with aspects of FIG. 6 discussed above.

In an implementation, a binarize_and_stuff_data operation transforms the unioned logs and changes them for a machine learning (ML) model. In an embodiment, such an ML model may correspond to the usage and context model discussed before in FIG. 5, or classifier model 632. In an embodiment, the ML model represents an aggregation of several models such as a logistic regression model and a revocation recommendation model (e.g., a type of model that provides a recommendation or prediction such as one that uses one or more filtering techniques (e.g., generating predictions by analyzing user behavior), and the like), clustering models, user-based k-nearest neighbors, matrix factorization, Bayesian networks, and the like).

In an implementation, a generate_train_data_set operation generates a training data set that contains predictor and target variables over a given time frame. In addition to the employee metadata, quantitative features relevant to time-series variables are utilized to capture usage frequency and recency:
Recency: work_days_since latest_authentication and
log_of_work_days_since_latest_authentication measure how recently a user was active. The subject technology uses work days to normalize the model over periods when users are less active, such as the holidays.
Frequency: authentications_per_day and weighted_authentications_per_day measure how frequently a user is active. Authentications per day count the number of authentications, while weighted_authentications_per_day weighs each day based on a half-life equation. When the half_life_variable parameter is set to 30, authentications that occurred 30 days ago are provided half the weight of authentications that happened on the day of training.
The target variable is did_not_login, which translates to the likelihood of the user not using the application for the next x days. The parameter is set to 30 by default but is configurable to any time frame.

In an implementation, a train_test_all_folds_give_results operation is used to see how the model would historically have performed given a certain set of parameters. In an example, the threshold for revocation is set at 50%, meaning revoking licenses from users who have a greater than 50% probability of not using the application within the next 30 days. Moreover, the model performs better over time as the size of the training data set grows.

In an implementation, a run_model_today operation runs the model based on data up until today and provides a probability that each employee will use the application within the next 30 days. The output, revocation_recommendations_today, is a list of employees who the model recommends revoking today.

In the discussion of FIG. 6 above, it is appreciated that one or more of database 610, database 612, database 614, database 616, database 628, or database 620 can be combined in a single database that aggregates data from the combined databases. Further, one or more of the aforementioned databases can be provided by metadata database 112, storage platform 104, or access metadata database 206 discussed before.

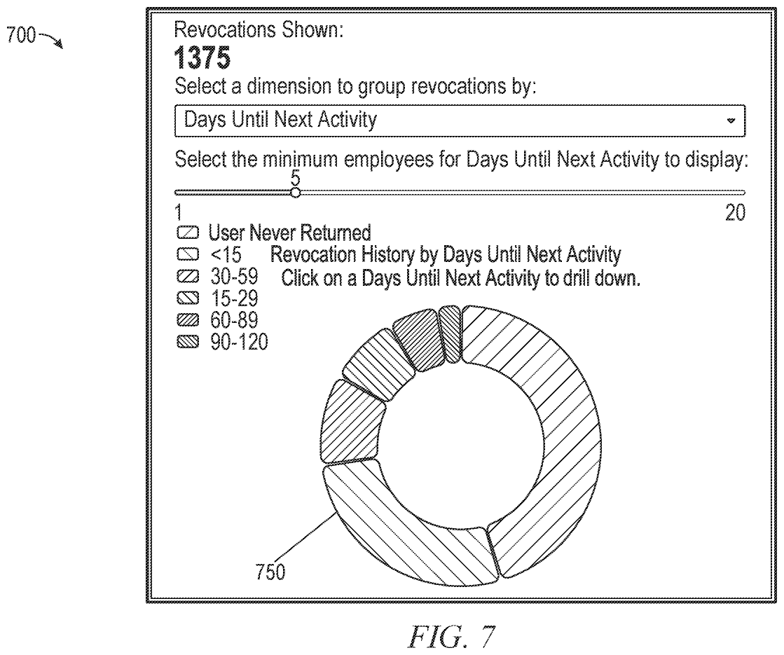

FIG. 7 illustrates an example interface 700 in accordance with an embodiment of the subject technology.

After one visualization in the application is created, the user of the application has the option to drill down further into a particular component. For example, the user can drill into section 750 of the above pie chart to look closer at the 377 users who returned in less than 15 days, and see how many times they actually logged into the application within the next 30 days.

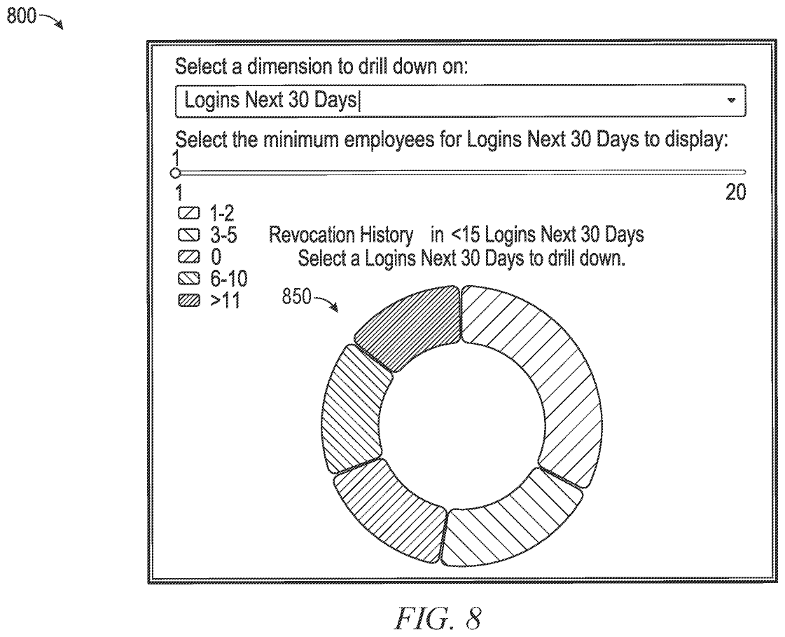

FIG. 8 illustrates an example interface 800 in accordance with an embodiment of the subject technology.

As chart 850 shows, a handful of users file tickets to re-request access shortly after their licenses are revoked, but do not actually use the application.

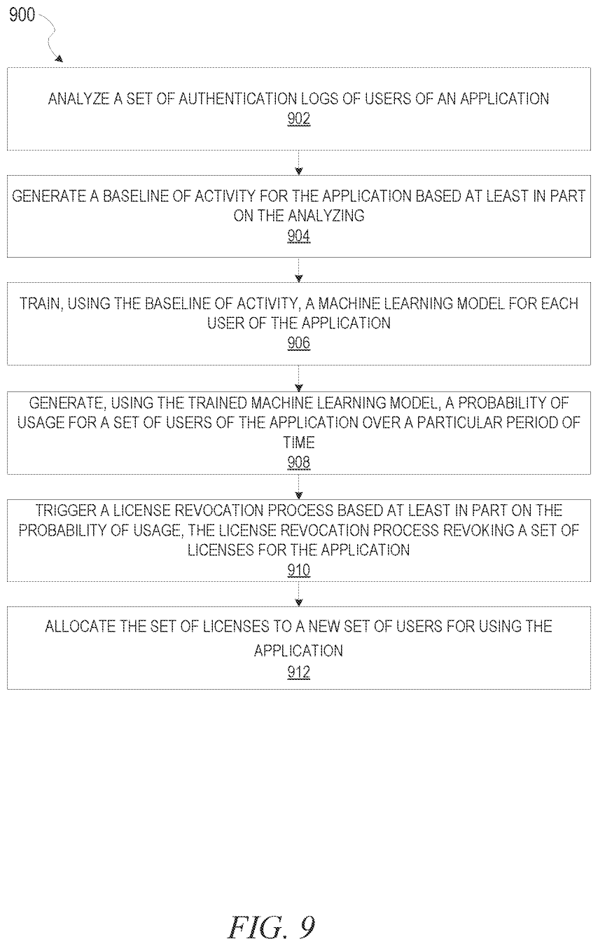

FIG. 9 is a flow diagram illustrating operations of a database system in performing a method, in accordance with some embodiments of the present disclosure. The method 900 may be embodied in computer-readable instructions for execution by one or more hardware components (e.g., one or more processors) such that the operations of the method 900 may be performed by components of network-based database system 102, such as components of the compute service manager 108 or a node in the execution platform 110. Accordingly, the method 900 is described below, by way of example with reference thereto. However, it shall be appreciated that the method 900 may be deployed on various other hardware configurations and is not intended to be limited to deployment within the network-based database system 102.

At operation 902, execution node 302-1 analyzes a set of authentication logs of users of an application.

At operation 904, execution node 302-1 generates a baseline of activity for the application based at least in part on the analyzing.

At operation 906, execution node 302-1 trains, using the baseline of activity, a machine learning model for each user of the application.

At operation 908, execution node 302-1 generates, using the trained machine learning model, a probability of usage for a set of users of the application over a particular period of time.

At operation 910, execution node 302-1 triggers a license revocation process based at least in part on the probability of usage, the license revocation process revoking a set of licenses for the application.

At operation 912, execution node 302-1 allocates the set of licenses to a new set of users for using the application.

In an embodiment, generating, using the trained machine learning model, the probability of usage for the application over the particular period of time comprises: analyzing, by the machine learning model, a recency and a frequency of activity of the application; converting the recency and the frequency of activity to a set of activity patterns; and providing, using the set of activity patterns, a prediction indicating the probability of usage over the particular period of time.

In an embodiment, triggering the license revocation process based at least in part on the probability of usage comprises: determining a set of probabilities of usage for a particular set of users of the application; and determining that the probabilities of usage of a second set of users is below a threshold value. In an embodiment, revoking a particular set of licenses of the application associated with the second set of users.

In an embodiment, the particular set of licenses increases a particular number of available licenses of the application for provisioning to the new set of users.

In an embodiment, execution node 302-1 determines a particular number of valid revocations, and modifying an application popularity matrix based at least in part on the particular number of valid revocations.

In an embodiment, execution node 302-1 determines a particular number of invalid revocations; and modifying an application popularity matrix based at least in part on the particular number of invalid revocations.

In an embodiment, the application popularity matrix comprises information related to a number of access requests for the application in which a license is provided.

In an embodiment, allocating the set of licenses to the new set of users occurs during a pre-hire stage or a first day of the new set of users.

In an embodiment, execution node 302-1 sends a notification that the set of licenses for the application have been revoked.

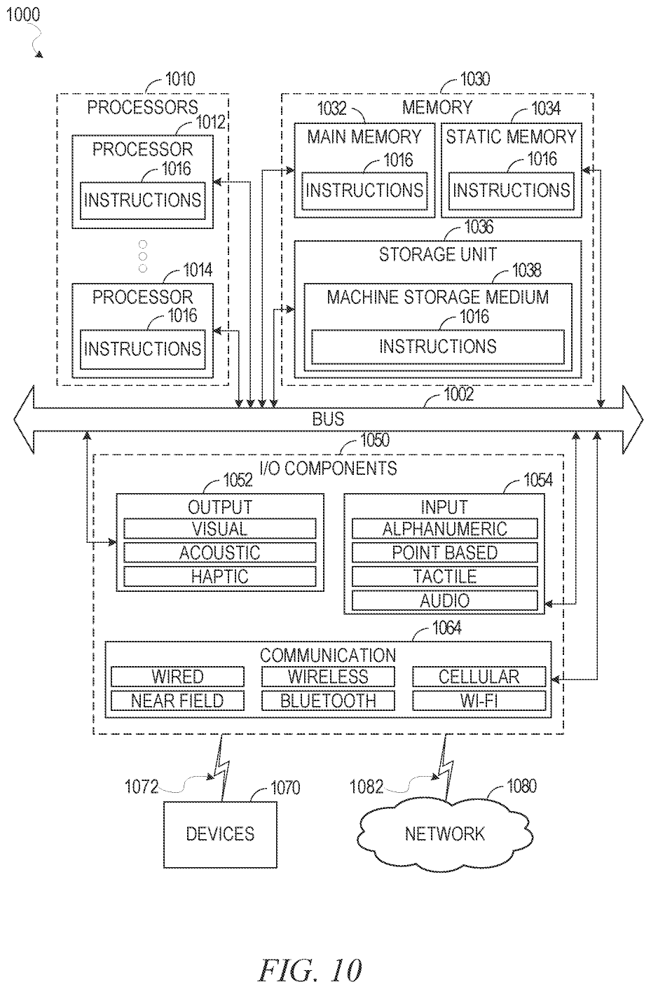

FIG. 10 illustrates a diagrammatic representation of a machine 1000 in the form of a computer system within which a set of instructions may be executed for causing the machine 1000 to perform any one or more of the methodologies discussed herein, according to an example embodiment. Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. In this way, the instructions 1016 transform a general, non-programmed machine into a particular machine 1000 (e.g., the compute service manager 108 or a node in the execution platform 110) that is specially configured to carry out any one of the described and illustrated functions in the manner described herein.

In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 includes processors 1010, memory 1030, and input/output (I/O) components 1050 configured to communicate with each other such as via a bus 1002. In an example embodiment, the processors 1010 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1012 and a processor 1014 that may execute the instructions 1016. The term “processor” is intended to include multi-core processors 1010 that may comprise two or more independent processors (sometimes referred to as “cores”) that may execute instructions 1016 contemporaneously. Although FIG. 10 shows multiple processors 1010, the machine 1000 may include a single processor with a single core, a single processor with multiple cores (e.g., a multi-core processor), multiple processors with a single core, multiple processors with multiple cores, or any combination thereof.

The memory 1030 may include a main memory 1032, a static memory 1034, and a storage unit 1036, all accessible to the processors 1010 such as via the bus 1002. The main memory 1032, the static memory 1034, and the storage unit 1036 store the instructions 1016 embodying any one or more of the methodologies or functions described herein. The instructions 1016 may also reside, completely or partially, within the main memory 1032, within the static memory 1034, within machine storage medium 1038 of the storage unit 1036, within at least one of the processors 1010 (e.g., within the processor's cache memory), or any suitable combination thereof, during execution thereof by the machine 1000.

The I/O components 1050 include components to receive input, provide output, produce output, transmit information, exchange information, capture measurements, and so on. The specific I/O) components 1050 that are included in a particular machine 1000 will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion and the grouping is in no way limiting. In various example embodiments, the I/O components 1050 may include output components 1052 and input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 1054 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 1050 may include communication components 1064 operable to couple the machine 1000 to a network 1080 or devices 1070 via a coupling 1082 and a coupling 1072, respectively. For example, the communication components 1064 may include a network interface component or another suitable device to interface with the network 1080. In further examples, the communication components 1064 may include wired communication components, wireless communication components, cellular communication components, and other communication components to provide communication via other modalities. The devices 1070 may be another machine or any of a wide variety of peripheral devices (e.g., a peripheral device coupled via a universal serial bus (USB)). For example, as noted above, the machine 1000 may correspond to any one of the compute service manager 108 or the execution platform 110, and the devices 1070 may include the client device 114 or any other computing device described herein as being in communication with the network-based database system 102 or the cloud storage platform 104.

### Executable Instructions and Machine Storage Medium

The various memories (e.g., 1030, 1032, 1034, and/or memory of the processor(s) 1010 and/or the storage unit 1036) may store one or more sets of instructions 1016 and data structures (e.g., software) embodying or utilized by any one or more of the methodologies or functions described herein. These instructions 1016, when executed by the processor(s) 1010, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple non-transitory storage devices and/or non-transitory media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 1080 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network, and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1016 may be transmitted or received over the network 1080 using a transmission medium via a network interface device (e.g., a network interface component included in the communication components 1064) and utilizing any one of a number of well-known transfer protocols (e.g., hypertext transfer protocol (HTTP)). Similarly, the instructions 1016 may be transmitted or received using a transmission medium via the coupling 1072 (e.g., a peer-to-peer coupling) to the devices 1070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1016 for execution by the machine 1000, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of methods may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

### CONCLUSION

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor, and
a memory storing instructions that cause the at least one hardware processor to perform operations comprising:
analyzing a set of authentication logs of users of an application;
generating a baseline of activity for the application based at least in part on the analyzing;
training, using the baseline of activity, a machine learning model for each user of the application;
generating, using the trained machine learning model, a probability of usage for a set of users of the application over a particular period of time;
triggering a license revocation process based at least in part on the probability of usage, the license revocation process revoking a set of licenses for the application; and
allocating the set of licenses to a new set of users for using the application.

2. The system of claim 1, wherein generating, using the trained machine learning model, the probability of usage for the application over the particular period of time comprises:
analyzing, by the machine learning model, a recency and a frequency of activity of the application;
converting the recency and the frequency of activity to a set of activity patterns; and
providing, using the set of activity patterns, a prediction indicating the probability of usage over the particular period of time.

3. The system of claim 1, wherein triggering the license revocation process based at least in part on the probability of usage comprises:
determining a set of probabilities of usage for a particular set of users of the application; and
determining that the probabilities of usage of a second set of users is below a threshold value.

4. The system of claim 3, wherein the operations further comprise:
revoking a particular set of licenses of the application associated with the second set of users.

5. The system of claim 4, wherein the particular set of licenses increases a particular number of available licenses of the application for provisioning to the new set of users.

6. The system of claim 1, wherein the operations further comprise:
determining a particular number of valid revocations; and
modifying an application popularity matrix based at least in part on the particular number of valid revocations.

7. The system of claim 1, wherein the operations further comprise:
determining a particular number of invalid revocations; and
modifying an application popularity matrix based at least in part on the particular number of invalid revocations.

8. The system of claim 7, wherein the application popularity matrix comprises information related to a number of access requests for the application in which a license is provided.

9. The system of claim 1, wherein allocating the set of licenses to the new set of users occurs during a pre-hire stage or a first day of the new set of users.

10. The system of claim 1, wherein the operations further comprise:
sending a notification that the set of licenses for the application have been revoked.

11. A method comprising:
analyzing a set of authentication logs of users of an application;
generating a baseline of activity for the application based at least in part on the analyzing;
training, using the baseline of activity, a machine learning model for each user of the application;
generating, using the trained machine learning model, a probability of usage for a set of users of the application over a particular period of time;
triggering a license revocation process based at least in part on the probability of usage, the license revocation process revoking a set of licenses for the application; and
allocating the set of licenses to a new set of users for using the application.

12. The method of claim 11, wherein generating, using the trained machine learning model, the probability of usage for the application over the particular period of time comprises:
analyzing, by the machine learning model, a recency and a frequency of activity of the application;
converting the recency and the frequency of activity to a set of activity patterns; and
providing, using the set of activity patterns, a prediction indicating the probability of usage over the particular period of time.

13. The method of claim 11, wherein triggering the license revocation process based at least in part on the probability of usage comprises:
determining a set of probabilities of usage for a particular set of users of the application; and
determining that the probabilities of usage of a second set of users is below a threshold value.

14. The method of claim 13, further comprising:
revoking a particular set of licenses of the application associated with the second set of users.

15. The method of claim 14, wherein the particular set of licenses increases a particular number of available licenses of the application for provisioning to the new set of users.

16. The method of claim 11, further comprising:
determining a particular number of valid revocations; and
modifying an application popularity matrix based at least in part on the particular number of valid revocations.

17. The method of claim 11, further comprising:
determining a particular number of invalid revocations; and
modifying an application popularity matrix based at least in part on the particular number of invalid revocations.

18. The method of claim 17, wherein the application popularity matrix comprises information related to a number of access requests for the application in which a license is provided.

19. The method of claim 11, wherein allocating the set of licenses to the new set of users occurs during a pre-hire stage or a first day of the new set of users.

20. A non-transitory computer-storage medium comprising instructions that, when executed by one or more processors of a machine, configure the machine to perform operations comprising:
analyzing a set of authentication logs of users of an application;
generating a baseline of activity for the application based at least in part on the analyzing;
training, using the baseline of activity, a machine learning model for each user of the application;
generating, using the trained machine learning model, a probability of usage for a set of users of the application over a particular period of time;
triggering a license revocation process based at least in part on the probability of usage, the license revocation process revoking a set of licenses for the application; and
allocating the set of licenses to a new set of users for using the application.
